(19) United States
(12) Patent Application Publication
(10) Pub. No.: US 2007/0126133 A1
(43) Pub. Date: Jun. 7, 2007

(54) Vena contracta

(76) Inventors: Mark A. Galgano, Medina, OH (US); Greg Rondy, Seville, OH (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/344,863

(22) Filed: Feb. 1, 2006

Related U.S. Application Data
(63) Continuation of application No. 11/298,333, filed on Dec. 7, 2005.

(51) Int. Cl. B01D 47/02

(52) U.S. Cl. 261/77

(57) ABSTRACT

A vena contracta, converging/diverging nozzle, or orifice plate that allows the saturation of oxygen in water to exceed 100 percent is disclosed. A flow of water is directed toward the outlet end of the vena contracta, converging/diverging nozzle, or orifice plate and a flow of air is directed into the inlet end thereof. The direction of the flow of water is opposite to the direction of the flow of air. The flow of air passes through an orifice in the vena contracta or converging/diverging nozzle, or through the orifice plate and creates a shock wave adjacent the outlet end thereof. The shock wave creates a mass transfer interface permitting the saturation of oxygen in the water to exceed 100 percent. The supersaturated water then exits past the vena contracta, converging/diverging nozzle, or orifice plate for discharge through a piping system into a pond, water reservoir or such containment area as is required by a particular application.

### CROSS REFERENCE TO RELATED APPLICATIONS

This application is a continuation of U.S. patent application Ser. No. 11/298,333 filed Dec. 7, 2005.

### TECHNICAL FIELD

The present invention relates, in general, to a venturi-type device or an orifice plate that operates at sonic or subsonic velocities and, more particularly, to a venturi-type device or an orifice plate that operates at sonic or subsonic conditions and employs air as the motive gas.

### BACKGROUND ART

Venturis operating at sonic or subsonic velocities have been utilized to remove sub-micron particulates from gas streams, create vacuum for industrial applications and saturate liquids with oxygen. With respect to the saturation of liquids, levels of absorption using sonic or subsonic velocity venturis employing air as the motive gas have been limited to about 70 percent saturation of oxygen in water. Higher levels of saturation are desirable but have been unattainable using present venturi devices and methods of operating same.

In view of the limitations as to the saturation of oxygen in water using present venturi devices and the methods of operating same, it has become desirable to develop a venturi-type device or orifice plate and a method of operating same that permits the saturation of oxygen in water to levels that approach and/or exceed 100 percent saturation.

### SUMMARY OF THE INVENTION

The present invention solves the problems associated with the limitation of saturation of oxygen in water using presently available venturi devices and other problems by providing a venturi-type device, hereinafter referred to as a vena contracta or a converging/diverging nozzle, wherein the suction port thereto is eliminated causing the device to act as a flow-through device. Alternatively, an orifice plate can be utilized for the same purpose. The vena contracta, converging/diverging nozzle, or orifice plate of the present invention operates at sonic or subsonic velocities to produce a high velocity gas stream that contacts a liquid stream moving in the opposite direction creating a high efficiency mass transfer interface that permits the super saturation of gases in the liquid. Rather than saturating oxygen in water, the device of the present invention can also be used to strip oxygen from water when steam is used as the motive force. Thus, various motive fluids may be utilized permitting the absorption of gases into liquids or the stripping of gases from liquids.

Several conditions are required with respect to the operation of the vena contracta, converging/diverging nozzle, or orifice plate of the present invention. For example, in order for the vena contracta, converging/diverging nozzle, or orifice plate of the present invention to operate optimally, it must be operated at sonic or near sonic velocities and the direction of the air flow must be opposite to the direction of the liquid flow to be treated. In addition, the mass ratio of liquid to gas and the total pressure of the liquid are critical factors with respect to the operation of the device. Also, the overall performance of the device is affected by the inlet liquid temperature, the motive pressure of the gas and the in-line liquid pressure. It should be noted that the performance of the device is not affected by the inlet oxygen content (or other gas concentration for absorption or gas stripping) of the liquid and the total liquid flow.

### BRIEF DESCRIPTION OF THE DRAWINGS

Figure is a cross-sectional view of the vena contracta or converging/diverging nozzle of the present invention within a liquid supply line.

FIG. 2 is a cross-sectional view of an alternate embodiment of the present invention in the form of an orifice plate within a liquid supply line.

FIG. 3 is a graph of Total System Flow (GPM) versus Total System Pressure (PSI) illustrating the percent saturation of oxygen in water for slightly less than and more than 100 percent saturation levels.

FIG. 4 is a graph of Total System Pressure (PSI) versus Exit Saturation (%) for various system flow rates.

### DESCRIPTION OF THE PREFERRED EMBODIMENT

Referring now to the drawings where the illustrations are for the purpose of describing the preferred embodiment of the present invention and are not intended to limit the invention disclosed herein. FIG. 1 is a cross-sectional view of the vena contracta or converging/diverging nozzle 10 of the present invention positioned within a liquid supply line 12. The vena contracta or converging/diverging nozzle 10 of the present invention can be fabricated from a metallic or non-metallic material and is typically cylindrical in cross-section. The vena contracta or converging/diverging nozzle 10 has an inlet end 14, an outlet end 16, and an orifice 18 disposed therein and interposed between the inlet end 14 and the outlet end 16. The internal surface 20 of the vena contracta or converging/diverging nozzle 10 between the inlet end 14 and the orifice 18 is tapered inwardly toward the orifice 18 whereas the internal surface 22 of the vena contracta or the converging/diverging nozzle 10 between the orifice 18 and the outlet end 16 is tapered outwardly toward the outlet end 14. It should be noted that the aforementioned tapers can vary and can be compounded. The orifice 18 is typically round in configuration. It should be further noted that the vena contracta or converging/diverging nozzle 10 is similar to a venturi but has no suction port.

Operationally, a liquid, such as water, is provided within the liquid supply line 12. The flow rate of the liquid is generally about 2 to 40 fps. A gas, such as air, having a pressure of generally about 50 to 200 psig is introduced into the vena contracta or converging/diverging nozzle 10 via its inlet end 14. The direction of the gas flow is opposite to the direction of the flow of the liquid. The pressure of the air in the portion of the vena contracta or converging/diverging nozzle 10 defined by the orifice 18 and the outlet end 16 is generally 45 to 150 psig. The air exits the outlet end 16 of the vena contracta or converging/diverging nozzle 10 at a high velocity creating a shock wave that moves outwardly therefrom into the liquid. The shock wave contacts the liquid stream creating a high efficiency interface permitting the supersaturation of gases within the liquid. In this manner the saturation of oxygen in the water can approach, equal or exceed 100 percent. It was found that as the water pressure increased, the percent saturation of oxygen in water also increased. The supersaturated liquid passes through the area defined by the outer surface 24 of the vena contracta or converging/diverging nozzle 10 and the inner surface 26 of the liquid supply line 12 and exits outwardly therefrom.

In addition to the matter that the direction of the flow of gas is opposite to the direction of the flow of liquid; that the pressure of the gas is generally about 50 to 200 psig and that the gas flow exiting the outlet end 16 of the vena contracta or converging/diverging nozzle 10 is at a high velocity; and that the liquid flow rate is generally about 2 to 40 fps, there are other factors that affect the operation of the vena contracta or converging/diverging nozzle 10 of the present invention. For example, the temperature of the liquid and the vapor pressure of the gas to be saturated into the liquid or stripped therefrom are critical to the operation of the vena contracta or converging/diverging nozzle 10 of the present invention.

It should be noted that any type of gas and/or liquid can be utilized with the vena contracta or converging/diverging nozzle 10 of the present invention under the aforementioned operating conditions. For example, air can be utilized to saturate oxygen in water; steam (gas) can be utilized to strip oxygen from a liquid; and compressed air can be utilized to strip volatile organic compounds (VOCs) from liquids. This latter process is known as remediation. Stripping air/oxygen from products that contain liquids such as foods, beverages, cosmetics, chemicals, paints, etc., enhances the shelf life of same.

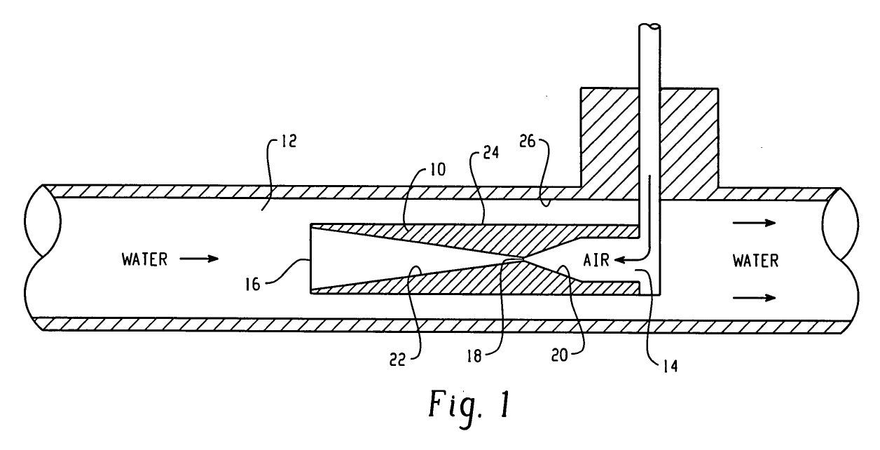

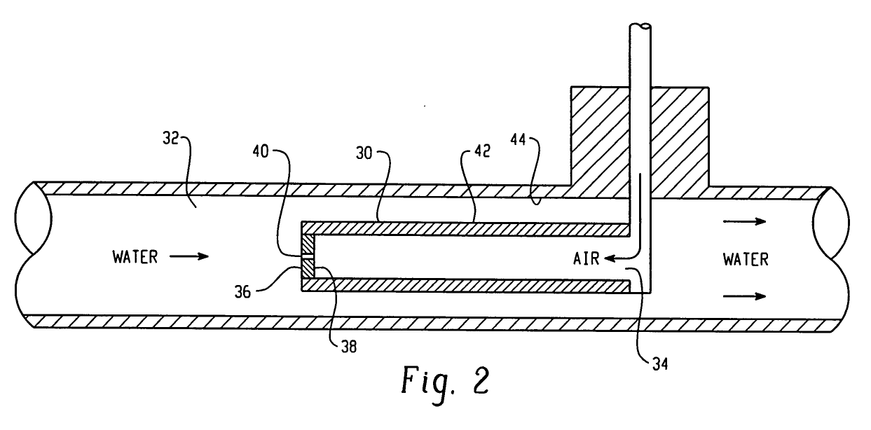

Referring now to FIG. 2, a cross-sectional view of another embodiment of the present invention is illustrated. In this Figure, a section of pipe in the form of a pipe nipple 30, or the like, is utilized and is disposed within a liquid supply line 32. The pipe nipple 30 is typically circular in cross-section and has an inlet end 34, an outlet end 36, and an orifice plate 38 disposed within its outlet end 36. The orifice plate 38 has an orifice 40 therein. The orifice 40 has a generally circular cross-section disposed generally centrally within the orifice plate 38. In this embodiment, no inlet end or outlet end tapers are required.

As in the previous embodiment, a liquid, such as water, is provided within the liquid supply 32. A gas, such as air, is introduced into the pipe nipple 30 via its inlet end 34. The direction of the gas flow is opposite to the direction of the flow of the liquid. The air exiting the outlet end 36 of the pipe nipple 30 is at a high velocity creating a shock wave that moves outwardly therefrom into the liquid. The shock wave contacts the liquid stream creating a high efficiency interface permitting the supersaturation of gases within the liquid. The supersaturated liquid passes through the area defined by the outer surface 42 of the pipe nipple 30 and the inner surface 44 of the liquid supply line 32 and exits therefrom. It should be noted that this embodiment of the present condition operates under similar conditions with respect to flow rates and pressures as in the previous embodiment. It is reasonable to assume by those familiar with the art that this embodiment of the present invention will produce results similar to those produced by the previous embodiment, i.e., the saturation of oxygen in water approaching, equaling or exceeding 100 percent, when operated under similar conditions.

It should be noted that a larger liquid supply line 12 would necessitate the use of a larger vena contracta, converging/diverging nozzle, or multiple thereof. Similarly, the practice of the technology using an orifice plate in a larger supply line 32 would necessitate the use of a larger orifice 40 in the orifice plate 38 or an orifice plate having multiple orifices therein (not shown). Certain geometric similarities must be maintained as the size of the liquid supply line is changed.

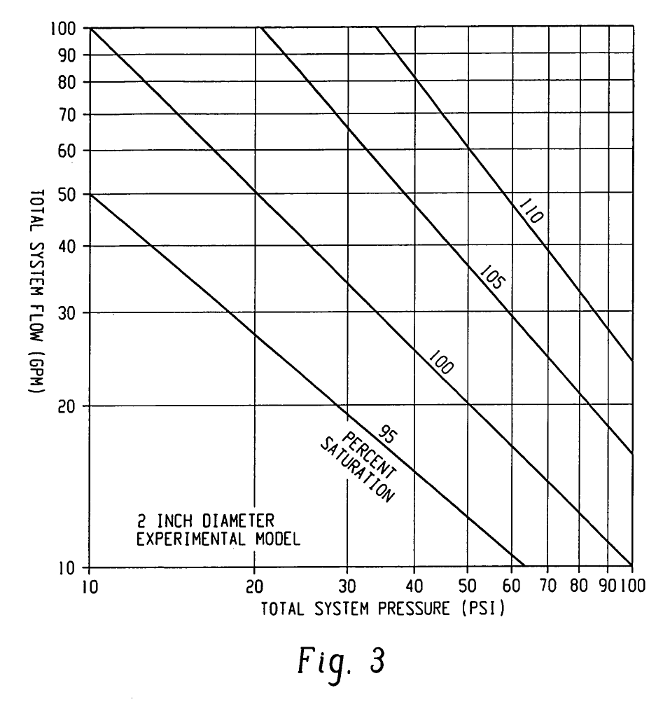

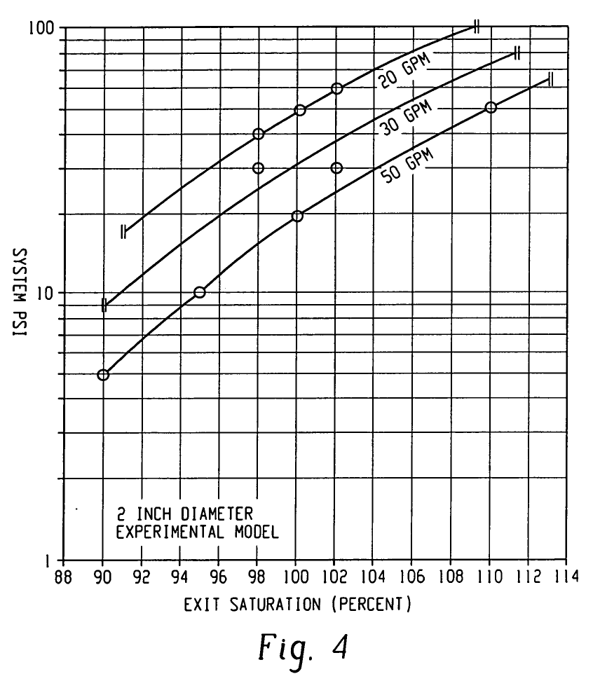

Referring now to FIG. 3, a graph of Total System Flow (GPM) versus Total System Pressure (PSI) is shown. This graph illustrates that by using the vena contracta or converging/diverging nozzle 10 of the present invention under specific operating conditions, saturation levels of oxygen in water can approach or exceed 100 percent. FIG. 4 is a graph of Total System Pressure (PSI) versus Exit Saturation (%) for various system flow rates and also illustrates that by using the vena contracta or converging/diverging nozzle 10 of the present invention under specific operating conditions, saturation levels of oxygen in water can approach or exceed 100 percent.

The vena contracta or converging/diverging nozzle 10 of the present invention is more effective than presently available apparatus used in application involving mass transfer. Such mass transfer applications include, but are not limited to, tray towers, spray towers, packed towers, static and dynamic mixers, sparger systems, cooling towers, membranes, spray ponds, distillation towers and ultraviolet purification and other advanced processes. Industrial applications for the vena contracta or converging/diverging nozzle 10 of the present invention and the method of operating same include, but are not limited to, purification of fresh water supplies, processing of industrial and municipal waste, chemical processing, beverage carbonation, food deaeration, boiler feed water deaeration, medical applications (i.e., blood purification, etc.), purification of pharmaceuticals, purification in metal and chemical processing, and research and development applications.

Certain modifications and improvements will occur to those skilled in the art upon reading the foregoing. It is understood that all such modifications and improvements have been deleted herefrom for the sake of conciseness and readability, but are properly within the scope of the following claims.

What is claimed:

1. A system for alteration of gas content of a liquid comprising:
a liquid conduit, the liquid conduit including means adapted for transporting an associated liquid in first flow direction there through; and
a gas conduit, the gas conduit including means adapted for injecting an associated gas into the liquid in a direction generally opposite to the first flow direction, the gas conduit including at least one constriction so as to increase a relative velocity of gas passing there through.

2. The system for alteration of gas content of a liquid of claim 1 further comprising a gas injector operatively connected to the gas conduit so as to introduce the associated gas therein at a selected pressure relative to a rate of the first flow so as to introduce a shockwave at an interface between the liquid and the gas.

3. The system for alteration of gas content of a liquid of claim 2 wherein the gas includes oxygen, whereby the shockwave introduces a supersaturation-level of oxygen into the liquid after contact between the liquid and the gas at the interface.

4. The system for alteration of gas content of a liquid of claim 2 wherein the gas includes steam, whereby the shockwave induces a lessening of a dissolved gas content of the liquid after contact between the liquid and the steam at the interface.

5. The system for alteration of gas content of a liquid of claim 3 wherein the liquid includes water, which water is supersaturated with oxygen after contact between the liquid and the gas at the interface.

6. The system for alteration of gas content of a liquid of claim 4 wherein the liquid includes water, from which water oxygen is removed after contact between the liquid and the gas at the interface.

7. The system for alteration of gas content of a liquid of claim 3 wherein the selected pressure is in the range of 50 to 200 psig.

8. The system for alteration of gas content of a liquid of claim 3 wherein the liquid flows through the liquid conduit at a rate in the range of 2 to 40 fps.

9. The system for alteration of gas content of a liquid of claim 7 wherein the liquid flows through the liquid conduit at a rate in the range of 2 to 40 fps.

10. A method for alteration of gas content of a liquid comprising the steps of:
receiving a liquid into a liquid conduit such that the liquid is transported in a first flow direction there through;
communicating gas via a gas conduit having at least one constriction so as to increase a relative velocity of gas passing there through;
injecting gas from the gas conduit into the liquid conduit in a direction generally opposite to the first flow direction.

11. The method for alteration of gas content of a liquid of claim 10 further comprising the step of introducing the associated gas into the gas conduit at a selected pressure relative to a rate of the first flow so as to introduce a shockwave at an interface between the liquid and the gas.

12. The method for alteration of gas content of a liquid of claim 11 further comprising the step of introducing the gas inclusive of oxygen, whereby the shockwave introduces a supersaturation level of oxygen into the liquid after contact between the liquid and the gas at the interface.

13. The method for alteration of gas content of a liquid of claim 11 further comprising the step of introducing the gas inclusive of steam whereby the shockwave induces a lessening of a dissolved gas content of the liquid after contact between the liquid and the steam at the interface.

14. The method for alteration of gas content of claim 12 wherein the liquid includes water, which water is super saturate with oxygen after contact between the liquid and the gas at the interface.

15. The method for alteration of gas content of a liquid of claim 13 wherein the liquid includes water, from which water oxygen is removed after contact between the liquid and the gas at the interface.
